(19) United States
(12) Patent Application Publication
(10) Pub. No.: US 2015/0350480 A1
(43) Pub. Date: Dec. 3, 2015

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Eiji NAKAHASHI, Kanagawa (JP)

(21) Appl. No.: 14/664,449

(22) Filed: Mar. 20, 2015

(30) Foreign Application Priority Data
May 29, 2014 (JP) 2014-111446

(51) Int. Cl. H04N 1/00; G06Q 20/14; G06Q 30/02; H04N 1/32

(52) U.S. Cl. CPC H04N 1/00941; H04N 1/00408; H04N 1/32106; G06Q 20/145; G06Q 30/0283; H04N 2201/0094

(57) ABSTRACT

An information processing apparatus includes a first module including an output unit that outputs first information responsive to information identifying a user, and second information related to a service used by the user, and a second module including a calculating unit that calculates a usage charge of the service corresponding to the first information and the second information output by the output unit.

### CROSS-REFERENCE TO RELATED APPLICATIONS

This application is based on and claims priority under 35 USC 119 from Japanese Patent Application No. 2014-111446 filed May 29, 2014.

### BACKGROUND

(i) Technical Field

The present invention relates to an information processing apparatus, an information processing method, and a non-transitory computer readable medium.

(ii) Related Art

In available systems, the charge for a service provided by an information processing apparatus, such as an image forming apparatus, is collected. In such a system, charge collection may be performed with a charge structure modified if a predetermined condition is satisfied.

### SUMMARY

According to an aspect of the invention, there is provided an information processing apparatus including a first module including an output unit that outputs first information responsive to information identifying a user, and second information related to a service used by the user, and a second module including a calculating unit that calculates a usage charge of the service corresponding to the first information and the second information output by the output unit.

### BRIEF DESCRIPTION OF THE DRAWINGS

Exemplary embodiments of the present invention will be described in detail based on the following figures, wherein:

FIG. 1 generally illustrates a billing system of an exemplary embodiment;

FIG. 2 is a block diagram illustrating a hardware configuration of an image forming apparatus;

FIG. 3 is a block diagram illustrating a hardware configuration of a settlement apparatus;

FIG. 4 is a block diagram illustrating a software configuration of the image forming apparatus;

FIG. 5 is a functional block diagram illustrating the image forming apparatus;

FIG. 6 is a flowchart illustrating a process performed by the image forming apparatus;

FIG. 7 illustrates an example of a correspondence table;

FIG. 8 illustrates an example of a logic described in a calculating program;

FIG. 9 is a flowchart illustrating a process performed by the image forming apparatus;

FIG. 10 is a functional block diagram illustrating an image forming apparatus as a modification of the exemplary embodiment; and

FIG. 11 is a flowchart illustrating a process of the modification of the exemplary embodiment.

### DETAILED DESCRIPTION

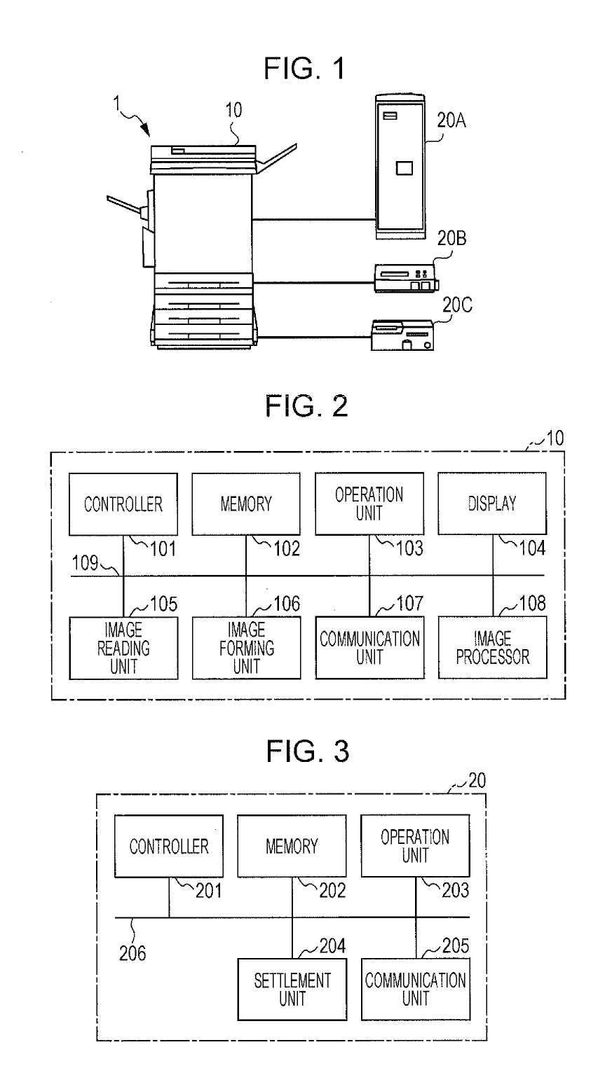

FIG. 1 generally illustrates a billing system 1 of an exemplary embodiment of the present invention. The billing system 1 provides a user with a service and bills the user for a charge for the service (hereinafter referred to as a service charge). The billing system 1 includes an image forming apparatus 10, and settlement apparatuses 20 (20A, 20B, and 20C). The image forming apparatus 10 is an information processing apparatus that functions as a photocopying machine, a printer, a scanner, or a facsimile machine. In response to a request from the user, the image forming apparatus 10 provides the user with a variety of services including a copy service, a print service, a scan service, and a facsimile service. The image forming apparatus 10 also calculates the service charge, and bills the user for the service charge (collets the service charge). The image forming apparatus 10 is used by the use who has been registered as a member for the use of the image forming apparatus 10. The image forming apparatus 10 calculates the service charge on a charge structure based on the membership type of the user registered as a member.

The settlement apparatus 20 collects the service charge calculated by the image forming apparatus 10. Referring to FIG. 1, the settlement apparatus 20A is a coin mechanism that collects a charge in coins. The settlement apparatus 20B is a magnetic card reader-writer that collects the charge via a magnetic card. The settlement apparatus 20C is an integrated circuit (IC) card reader that collects a charge via an IC card. The settlement apparatus 20C may be a contactless IC card reader-writer. The image forming apparatus 10 is interconnected each settlement apparatus 20 via a communication line, such as a universal serial bus (USE) cable.

FIG. 2 is a block diagram illustrating a hardware configuration of the image forming apparatus 10. As illustrated in FIG. 2, the image forming apparatus 10 includes a controller 101, a memory 102, an operation unit 103, a display 104, an image reading unit 105, an image forming unit 106, a communication unit 107, and an image processor 108. These elements in the image forming apparatus 10 are connected to a bus 109, and a variety of data is exchanged via the bus 109.

The controller 101 controls the operation of each element in the image forming apparatus 10. The controller 101 includes a central processing unit (CPU), and recording media, such a read-only memory (ROM) and a random-access memory (RAM). The CPU reads a program stored on the ROM and the memory 102, and executes the program using the RAM as a working area. By executing the program, the controller 101 forms an image on a paper sheet, generates image data of a document by reading the document, communicates with another apparatus via a communication line, or calculates a service charge and bills the calculated service charge.

The memory 102 stores data. The memory 102 includes a recording medium such as a hard disk or a flash memory, and stores data received by the communication unit 107 and data generated by the image forming apparatus 10. The memory 102 may include a removable medium, such as a memory card or a USB memory, and a unit that writes data to and reads data from the removable medium.

The operation unit 103 receives an operation of the user. The operation unit 103 includes a control (such as a button, or a key), and supplies the controller 101 with a control signal responsive to an operated control. The operation unit 103 includes a display 104, and a sensor overlaid on a display screen of the display 104. The operation unit 103 may include a touchpanel that supplies the controller 101 with a control signal responsive to a position where pressure is applied.

The display 104 displays information. The display 104 may include a liquid-crystal display, for example. The display 104, controlled by the controller 101, displays a menu screen configured to operate the image forming apparatus 10, and information related to a service provided by the image forming apparatus 10.

The image reading unit 105 reads an original document and converts the read original document into image data. The image reading unit 105 includes an image reader that optically reads the original document, and generates the image data representing the image of the read original document. The image reading unit 105 transfers the generated image data to the image processor 108.

The image forming unit 106 forms an image. The image forming unit 106 includes an image forming mechanism configured to form a toner image on a recording medium, such as a paper sheet, through an electrophotographic system. The image forming mechanism is not limited to an electrophotographic system, and may use another recording system, such as an ink-jet system.

The communication unit 107 transmits and receives data. The communication unit 107, connected to the communication line, functions as a communication interface configured to communicate with another apparatus connected to the communication line. The communication unit 107 may include an IC card reader configured to read information from an IC card.

The image processor 108 performs an image process on the image data. The image process includes color correction and color gradation correction. The image processor 108 transfers the image-processed image data to the image forming unit 106.

FIG. 3 is a block diagram illustrating a hardware configuration of the settlement apparatus 20. Referring to FIG. 3, the settlement apparatus 20 is a computer that includes a controller 201, a memory 202, an operation unit 203, a settlement unit 204, and a communication unit 205. These elements in the settlement apparatus 20 are connected to a bus 206, and exchange a variety of data via the bus 206.

The controller 201 controls the operation of each element in the settlement apparatus 20. The controller 201 includes an arithmetic processing unit such as a CPU, and recording media, such as a ROM and a RAM. The memory 202 stores data. The memory 202, including a recording medium, such as a flash memory, and stores data received by the communication unit 205. The operation unit 203 receives an operation of the user. The operation unit 203 includes controls (such as a button and a key), and transfers to the controller 201 a control signal responsive to a control that is operated. The settlement unit 204 collects a service charge. The settlement unit 204 in the settlement apparatus 20A may include a selector that selects coins, for example. The settlement unit 204 in the settlement apparatus 20B may include a magnetic head that reads information from and writes information to a magnetic card. The settlement unit 204 in the settlement apparatus 20C may include an antenna that reads information from and writes information to an IC card. The communication unit 205 transmits and receives data. The communication unit 205 functions as a communication interface that communicates with the image forming apparatus 10 via the communication line.

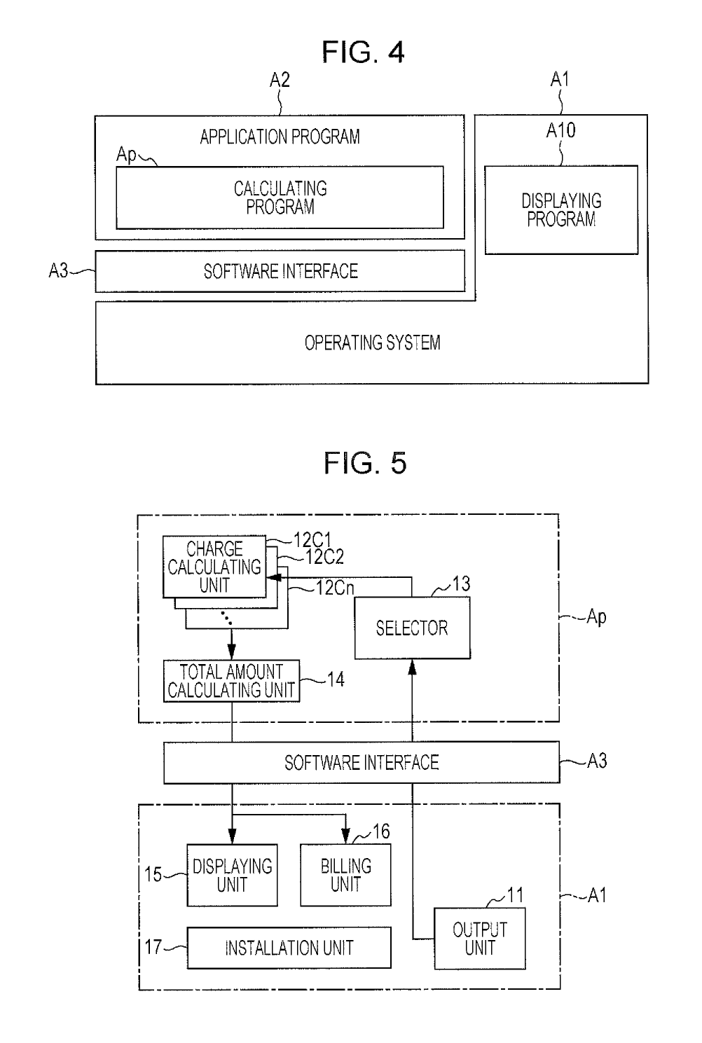

FIG. 4 is a block diagram illustrating a software configuration of the image forming apparatus 10. The image forming apparatus 10 stores an operating system A1 (an example of a first module) and an application program A2 on the memory 102. The operating system A1 manages execution of another program. The operating system A1 includes a displaying program A10. The displaying program A10 displays a variety of screens. For example, the displaying program A10 displays a screen configured to select, from among the settlement apparatuses 20, a settlement apparatus 20 that is used to pay a service charge, displays an amount of medium processed in the service, and displays the service charges.

The amount of medium is the number of images or the number of output sheets output by the image forming apparatus 10 as a result of a copying operation or the number of document sheets obtained as a result of scanning on the image forming apparatus 10, and the amount of medium is hereinafter referred to as an “amount of service used”. The application program A2 includes a variety of programs to add specific functions to the operating system A1. The application program A2 is installed on the image forming apparatus 10. The application program A2 cooperates with the operating system A1 via a software interface A3. As illustrated in FIG. 4, the application program A2 includes a calculating program Ap that adds to the operating system A1 a function to calculate the service charge. The calculating program Ap is an example of a second module.

FIG. 5 is a functional block diagram illustrating the image forming apparatus 10 that is implemented by executing the operating system A1 and the calculating program Ap. The image forming apparatus 10 includes an output unit 11, multiple charge calculating units 12 (12C1, 12C2, . . . , 12Cn), a selector 13, a total amount calculating unit 14, a displaying unit 15, a billing unit 16, and an installation unit 17. From among these functional elements, the controller 101 implements the output unit 11, the displaying unit 15, the billing unit 16, and the installation unit 17 by executing the operating system A1. The controller 101 implements the charge calculating units 12, the selector 13, and the total amount calculating unit 14 by executing the calculating program Ap.

The output unit 11 outputs to the selector 13 first information identifying a user, and second information related to a service used by the user. The selector 13 selects at least one charge calculating unit 12 that calculates a service charge from among the multiple charge calculating units 12 in accordance with the first information output from the output unit 11. The charge calculating unit 12 calculates the service charge corresponding to the information output from the output unit 11. The multiple charge calculating units 12 calculate the service charges in accordance with mutually difference logics. The total amount calculating unit 14 calculates a total sum of the service charges calculated by the calculating units 12. The displaying unit 15 displays the service charge calculated by the charge calculating unit 12 on the display 104. Referring to FIG. 5, the displaying unit 15 displays the total amount of the service charges calculated by the total amount calculating unit 14 on the display 104. The billing unit 16 bills the service charge calculated by the charge calculating units 12 using the settlement apparatus 20. As illustrated in FIG. 5, the billing unit 16 bills the total amount of service charges calculated by the total amount calculating unit 14. The installation unit 17 installs the program.

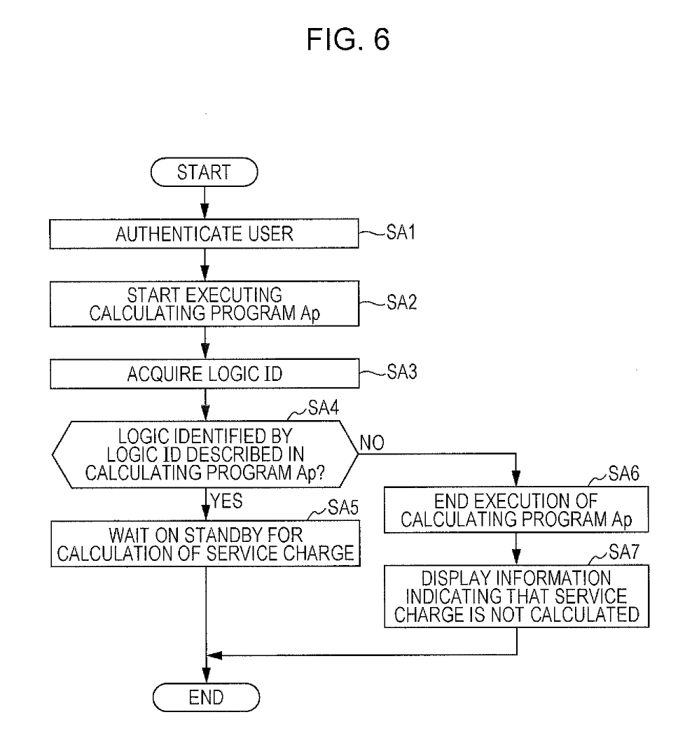

FIG. 6 is a flowchart illustrating a process performed by the image forming apparatus 10 before the service begins to be used. The process described below starts when the controller 101 executes the operating system A1 with the image forming apparatus 10 and the settlement apparatus 20 switched on. The controller 101 performs operations in steps SA1 through SA3, SA6, and SA7 by executing the operating system A1. The controller 101 performs operations in steps SA4 and SA5 by executing the calculating program Ap with the operating system A1 executed.

In step SA1, the controller 101 authenticates a user of the image forming apparatus 10. The user may be authenticated by holding an IC card close to a reader of the communication unit 107. The IC card stores a user ID identifying the user. The user ID includes information indicating a membership type of each user (such as a senior user, a student user, or a lady member). The memory 102 pre-stores the user ID of each user who has the right to use the image forming apparatus 10. The controller 101 reads the user ID stored on the IC card via the IC card reader, and successfully authenticates the user if the user ID is stored on the memory 102. The controller 101 stores the user ID of the authenticated user on the RAM. If the user ID fails to be read, or the read user ID is not stored on the memory 102, the controller 101 does not authenticate the user.

In step SA2, the controller 101 reads part of the calculating program Ap from the memory 102, and starts executing the calculating program Ap. In this way, the calculating program Ap responsive to the membership type of the user is executed.

In step SA3, the controller 101 acquires an identifier to select the charge calculating unit 12 that calculates the service charge from the multiple charge calculating units 12. The identifier is used to select a logic from among multiple logics, and hereinafter referred to as a “logic ID”. In the example of FIG. 6, each of the multiple charge calculating units 12 calculates the service charge of one of a variety of services provided by the image forming apparatus 10. The controller 101 acquires multiple logic IDs identifying the multiple charge calculating units 12 that calculate the service charges of the services. A table indicating correspondence between the user IDs and multiple logic IDs (hereinafter referred to as a “correspondence table”) is stored on the memory 102. The controller 101 acquires the multiple logic IDs corresponding to the user IDs of the users authenticated in step SA1 by referencing the correspondence table. The controller 101 stores the acquired multiple logic IDs on the RAM. The logic ID is an example of the first information.

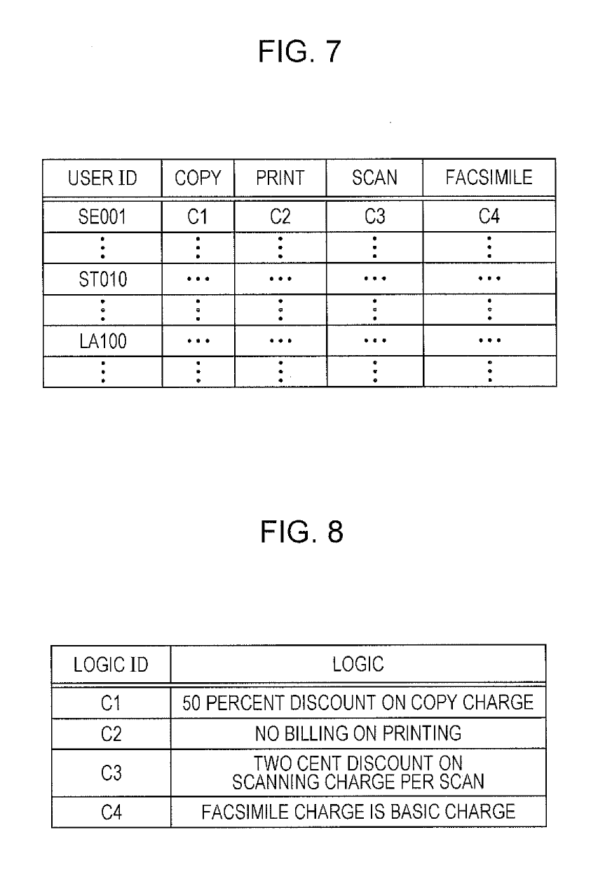

FIG. 7 illustrates an example of the correspondence table. Referring to FIG. 7, each user ID is associated with a logic ID on each type of service provided by the image forming apparatus 10. Two letters contained in each user ID indicates a membership type of the user in FIG. 7. For example, “SE” contained in the user ID indicates that the membership type is a senior member. In the example of FIG. 7, the user ID “SE001” of a senior member is associated with a logic ID “C1” for a copy service, a logic ID “C2” for a print service, a logic ID “C3” for a scan service, and a logic ID “C4” for a facsimile service. The logic IDs “C1”, “C2”, “C3”, and “C4” are IDs respectively identifying the charge calculating units 12C1, 12C2, 12C3, and 12C4, respectively. Letters “ST” contained in the user ID indicates the membership type is a student member. Letters “LA” contained in a user ID indicates that the membership type is a lady member. In this example, the logic ID of each service is associated with the user ID in accordance with the membership type of the user.

In step SA4, the controller 101 determines whether the logics identified by the multiple logic IDs stored on the RAM are described in the calculating program Ap that is being executed. The logic described in the calculating program Ap has a logic ID attached thereto. The controller 101 determines whether the logics having the multiple logic IDs stored on the RAM are described in the calculating program Ap. If the controller 101 determines that the logics having the multiple logic IDs stored on the RAM are described in the calculating program Ap (yes branch from step SA4), the controller 101 proceeds to step SA5. If the controller 101 determines that logics having multiple logic IDs stored on the RAM is not described in the calculating program Ap (no branch from step SA4), the controller 101 proceeds to step SA6.

In step SA5, the controller 101 waits on standby for the calculation of the service charge. More specifically, the controller 101 reads from the memory 102 the logics identified by the multiple logic IDs stored on the RAM, and then stores the read logics onto the RAM. In this way, the image forming apparatus 10 is ready to calculate the service charge in accordance with the logic responsive to the membership type of the user.

FIG. 8 illustrates an example of the logic described in the calculating program Ap. If the logic identified by the logic ID “C1” is read, a 50 percent discount is applied to a copy charge. If the logic identified by the logic ID “C2” is read, no charge is billed on printing. If the logic identified by the logic ID “C3” is read, a 2 cent discount is applied to the scan charge on a per scan basis. If the logic identified by the logic ID “C4” is read, neither discount nor extra charge is applied to the facsimile charge.

Referring back to FIG. 6, in step SA6, the controller 101 finishes executing the calculating program Ap. In step SA7, the controller 101 displays on the display 104 information indicating that the service charge is not calculated. The information indicating that the service charge is not calculated may include a message that the image forming apparatus 10 fails to meet the charge structure of the membership type of the user.

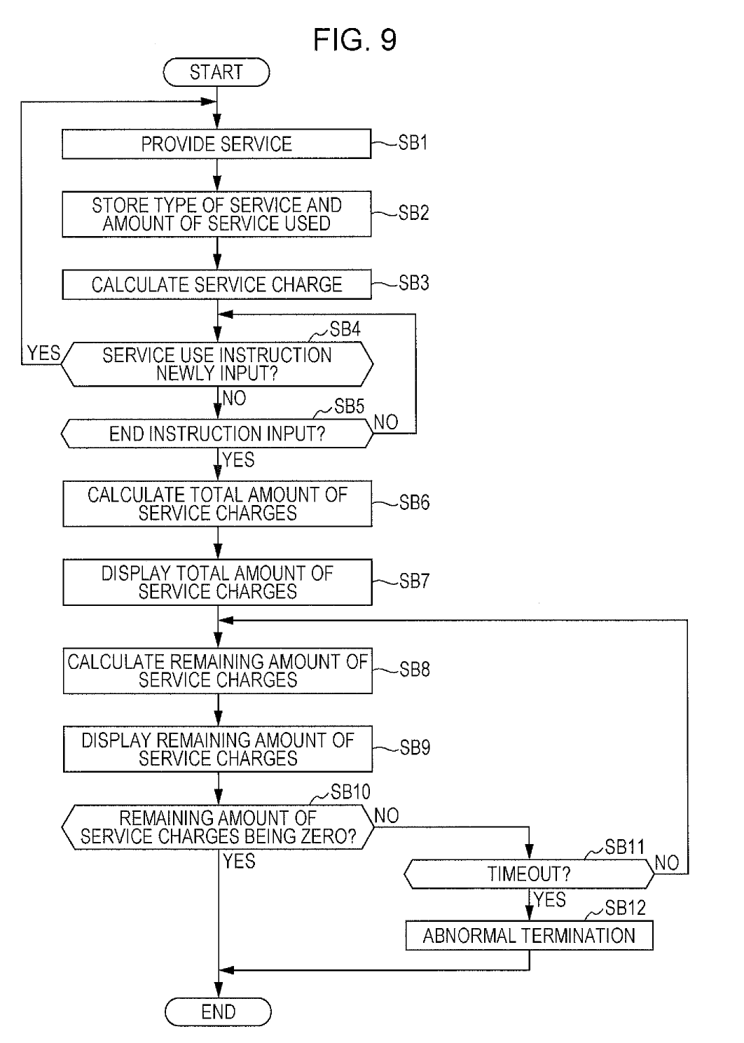

FIG. 9 is a flowchart illustrating a process the image forming apparatus performs subsequent to the start of the use of the service. The process discussed below is triggered by an input of an instruction to use service (hereinafter referred to as a “service use instruction”) with the controller 101 on standby for the calculation of the service charge. The user inputs the service use instruction by operating the operation unit 103. The service use instruction includes a variety of parameters related to a designate of a type of each service, and related to a service to be used. The controller 101 performs operations in steps SB1, SB2, SB4, SB5, SB7, and SB9 through SB12 by executing the operating system A1. The controller 101 performs operations in steps SB3, SB6, and SB8 by executing the calculating program Ap with the operating system A1 executed.

In step SB1, the controller 101 provides the service specified by the user. In step SB2, the controller 101 stores on the RAM the type of service used and an amount of service used. The type of service and the amount of service used are an example of the second information.

In step SB3, the controller 101 calculates the service charge. More specifically, the controller 101 identifies, from among multiple logics stored on the RAM, a logic on which the service charge of the service used is calculated. Each logic is with information that indicates the type of service. The controller 101 identifies the logic in accordance with the information. The controller 101 calculates the service charge of the amount of service used stored on the RAM, in accordance with the identified logic. For example, the basic charge for copy service may now be 10 cents per sheet, and the user having a user ID “SE001” may copy on three sheets. If the user having the user ID “SE001” is authenticated, the logic identified by the logic ID “C1” is read onto the RAM in the copy service. A 50 percent discount is applicable in this case, and the copy service charge is calculated as 15 cents. In another example, the basic scan charge may be 8 cents per scan, and the user having the user ID “SE001” may perform two scan operations. If the user having the user ID “SE001” is authenticated, the logic identified by the logic ID “C3” is read onto the RAM in the scan service. A 2 cent discount is applicable on each scan in this case, and the scan service charge is calculated as 12 cents. The controller 101 stores the calculated service charge on a per service type basis on the RAM.

In step SB4, the controller 101 determines whether a service use instruction has been newly input. If it is determined that a service use instruction has been newly input (yes branch from step SB4), the controller 101 returns to step SB1. If a service use instruction has not been input (no branch from step SB4), the controller 101 proceeds to step SB5.

In step SB5, the controller 101 determines whether an instruction to end the use of the image forming apparatus 10 (hereinafter referred to as an “end instruction”) has been input. For example, the user may input the end instruction by operating the operation unit 103. Upon determining that the end instruction has been input (yes branch from step SB5), the controller 101 proceeds to step SB6. Upon determining that the end instruction has not been input (no branch from step SB5), the controller 101 returns to step SB4.

In step SB6, the controller 101 calculates a total amount of service charges. More specifically, the controller 101 sums the service charges stored on the RAM. For example, if the user having the user ID “SE001” copies on thee sheets, and performs two scans, the controller 101 calculates a total amount of service charges as 27 cents. The controller 101 stores the calculated total amount of service charges on the RAM.

In step SB7, the controller 101 displays the total amount of service charges on the display 104. The user may check the total amount displayed on the display 104, and pays the charge using the settlement apparatus 20. When the service charge is paid, the settlement apparatus 20 transmits information indicating a payment mount (hereinafter referred to as “payment amount information”) to the image forming apparatus 10.

In step SB8, the controller 101 calculates a remaining amount in the service charge. More specifically, the controller 101 stores on the RAM the payment amount information transmitted from the settlement apparatus 20, and calculates a difference between the total amount of service charges and a value indicated by the payment amount information. The controller 101 thus calculates the remaining amount of service charge. The controller 101 stores the calculated remaining amount of service charge on the RAM. In step SB9, the controller 101 displays the remaining amount of service charge. In step SB10, the controller 101 determines whether the remaining amount of service charge is zero. Upon determining that the remaining amount of service charge is zero (yes branch from step SB10), the controller 101 ends the execution of the calculating program Ap, and then ends the process. Upon determining that the remaining amount of service charge is not zero (no branch from step SB10), the controller 101 proceeds to step SB11.

In step SB11, the controller 101 determines whether a predetermined period of time (namely, a time-out period) has elapsed since the display of the total amount of service charges. The controller 101 starts a timer when the total amount of service charges is displayed in step SB7. If it is determined that the time-out period has not elapsed (no branch from step SB11), the controller 101 returns to step SB8. If it is determined that the time-out period has elapsed (yes branch from step SB11), the controller 101 proceeds to step SB12. In step SB12, the controller 101 abnormally ends the process. After performing a predetermined process, the controller 101 quits the execution of the calculating program Ap.

Through the above process, the controller 101 executes the calculating program Ap, thereby calculating the service charge. The calculating program Ap is a program independent of the operating system A1. The calculating program Ap is thus designed in a manner not limited by the data structure of the operating system A1. Through the above process, the controller 101 calculates the service charge without communicating an external apparatus, such as a server apparatus that manages the image forming apparatus 10. This arrangement is free from an erroneous calculation of the service charge possibly caused by a sudden communication interruption with the external apparatus. Through the process, the service charge is calculated in accordance with the logic corresponding to the membership type of the user. The service charge is thus calculated based on a small amount of data and a variety of charge structures in comparison with the image forming apparatus 10 that stores, on each membership type of users, a table to be referenced to calculate the service charge.

The present invention is not limited to the exemplary embodiment, and a variety of modifications is possible. Several modifications are described below. The modifications described below may be used in combination.

### Modification 1

The controller 101 may calculate the service charge in a predetermined monetary unit from among monetary units of multiple countries.

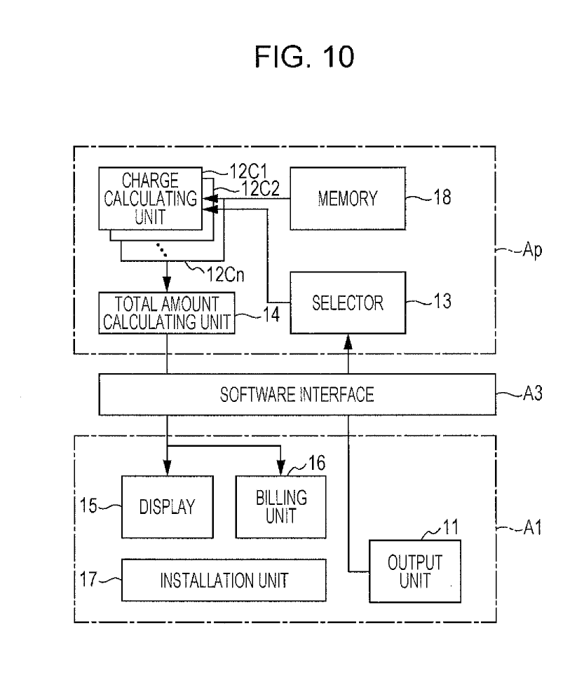

FIG. 10 is a functional block diagram illustrating an image forming apparatus as a modification of the exemplary embodiment. Referring to FIG. 10, the image forming apparatus 10 includes a memory 18 in addition of the functional blocks of FIG. 5. The memory 18 stores rates according to which the service charges are calculated in the monetary units of the countries. The controller 101 implements the memory 18 by executing the calculating program Ap. The charge calculating unit 12 calculates the service charge in the specified monetary unit based on the rate stored on the memory 18.

### Modification 2

Functions performed by the calculating program Ap are not limited to the functions described above. The calculating program Ap may add to the operating system A1 a function of displaying the service charge in place of the displaying program A10.

### Modification 3

Multiple calculating programs Ap different from each other in calculation method of the service charge may be installed on the image forming apparatus 10. The multiple calculating programs Ap to be installed may be respectively associated with the types of the settlement apparatus 20 connected to the image forming apparatus 10, the types of card for use in the payment of the service charge, or the membership types of users.

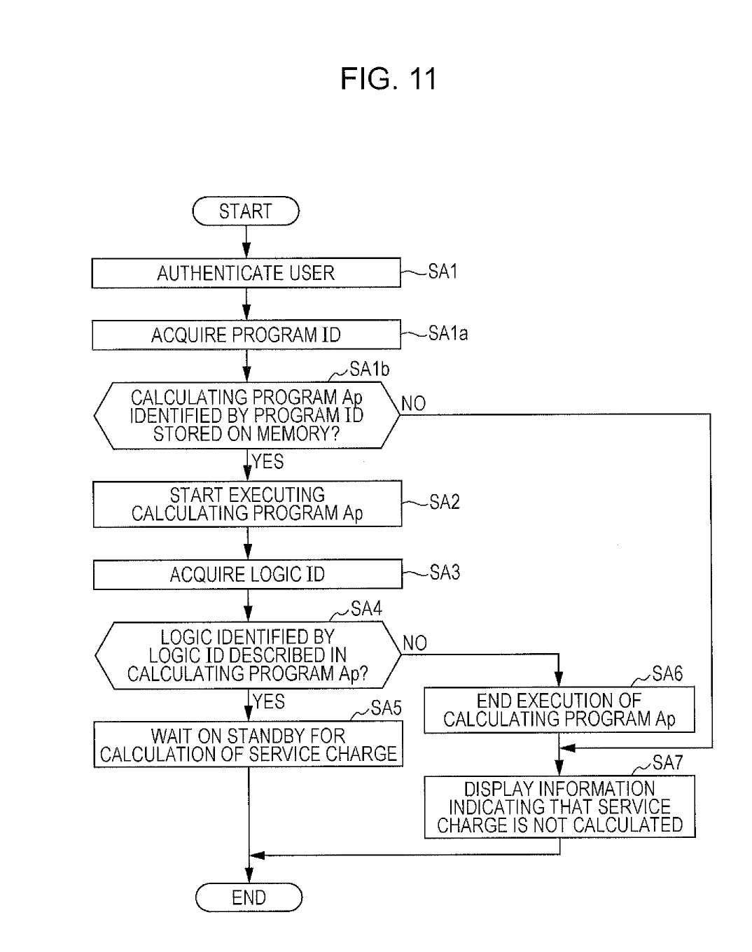

FIG. 11 is a flowchart illustrating a preparation process in which the image forming apparatus 10 calculates the service charge with the multiple calculating programs Ap installed on the image forming apparatus 10. The process of FIG. 11 is different from the process of FIG. 6 in that operations in steps SA1a and SA1b are performed. The controller 101 performs operations in steps SA1a and SA1b by executing the operating system A1.

In step SA1a, the controller 101 acquires an identifier (hereinafter referred to as a “program ID”) that selects a calculating program Ap to calculate the service charge from among the multiple calculating programs Ap. A program ID associated with the type of an IC card used in step SA1 is stored on the memory 102. The controller 101 acquires the program ID by reading the program ID associated with the type of the IC card used in step SA1 from the memory 102. The controller 101 stores the acquired program ID onto the RAM.

In step SA1b, the controller 101 determines whether the calculating program Ap identified by the program ID stored on the RAM is stored on the memory 102. In this example, a program ID is attached to each calculating program Ap stored on the memory 102. The controller 101 determines whether the calculating program Ap having the program ID stored on the RAM is stored on the memory 102. If it is determined that the calculating program Ap having the program ID stored on the RAM is stored on the memory 102 (yes branch from step SA1b), the controller 101 proceeds to step SA2. If it is determined that the calculating program Ap having the program ID stored on the RAM is not stored on the memory 102 (no branch from step SA1b), the controller 101 proceeds to step SA2.

### Modification 4

The logic for use in the calculation of the service charge is not limited to the one that is selected in accordance with the membership type of the users. The logic for use in the calculation of the service charge may be selected depending on another attribute of a user, such as a cumulative amount of past use of service by the user.

### Modification 5

Logics described in the calculating program Ap are not limited to the logics described in the exemplary embodiment. For example, a discount price may be applied when the amount of service used exceeds a predetermined amount. The charge calculating unit 12 may calculate the service charges of multiple services provided by the image forming apparatus 10. The logics identified by the logic IDs indicate calculation methods of service charges of the multiple services. For example, the logics of a given logic ID indicates the calculation methods of the service charges for the copy, print, scan, and facsimile services. In such a case, in step SA3, the controller 101 acquires at least one logic ID.

### Modification 6

The membership types of users are not limited to those described in the exemplary embodiment. The membership type may be different depending on the type of IC card used. For example, the user ID of IC card A may include information indicating that that user is a member of A society, and the user ID of IC card B may include information indicating that that user is a member of B society.

### Modification 7

The software configuration of the image forming apparatus 10 is not limited to the software configuration of FIG. 4. For example, the program to implement a function other than the function to calculate the service charge may be installed on the image forming apparatus 10. Services provided by the image forming apparatus 10 are not limited to the services described above.

### Modification 8

The user authentication method of the image forming apparatus 10 is not limited to the user authentication method described in the exemplary embodiment. For example, the image forming apparatus 10 may authenticate the user using an external server. The action to authenticate the user is not limited to holding the ID card close to the reader. For example, the user may enter the user ID and password for authentication by operating the operation unit 103.

### Modification 9

The information indicating the membership type of users may not necessarily have to be included in the user ID. For example, the image forming apparatus 10 may store the user ID and membership type in association with each other on the memory 102, and read the membership type associated with the user ID of the authenticated user. In another example, an external server apparatus may store the user ID and membership type in association with each other, and the image forming apparatus 10 may acquire from the server apparatus the membership type associated with the user ID of the authenticated user.

### Modification 10

The image forming apparatus 10 may be used by an unregistered user. In such a case, the image forming apparatus 10 may calculate the service charge based on the basic charge of each service.

### Modification 11

The process performed by the billing system 1 is not limited to the processes illustrated in FIG. 6 and FIG. 9. For example, the controller 101 may display the service charge responsive to the membership type of the user on the display 104. In another example, the controller 101 may display on the display 104 the calculated service charge on a per service type basis.

### Modification 12

The hardware configuration of the billing system 1 is not limited the hardware configuration described above. As long as the processes of FIG. 6 and FIG. 9 are performed, each apparatus may be configured in any hardware structure. For example, the settlement apparatus 20C may be a contact-type IC card reader-writer.

### Modification 13

If the function of the image forming apparatus 10 is implemented using a program, the program may be supplied in a state recorded on a non-transitory computer readable recording medium. The non-transitory recording media include magnetic recording media (a magnetic tape, a magnetic disk (such as hard disk drive (HDD) or a flexible disk (FD)), an optical recording medium (such as a compact disk (CD), or a digital versatile disk (DVD)), a magneto-optical recording medium, and a semiconductor memory. The program may be downloaded via a network, such as the Internet.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first module including an output unit that outputs first information responsive to information identifying a user, and second information related to a service used by the user; and
a second module including a calculating unit that calculates a usage charge of the service corresponding to the first information and the second information output by the output unit,
wherein the second module can be added to the information processing apparatus as an application.

2. The information processing apparatus according to claim 1,
wherein the second module comprises a plurality of the calculating units,
wherein the first information identifies the calculating units, and
wherein the calculating unit in the second module identified by the first information output by the output unit calculates the usage charge.

3. The information processing apparatus according to claim 2, wherein the second module comprises a selector unit that selects at least one of the calculating units configured to calculate the usage charge from among the calculating units in accordance with the first information output by the output unit.

4. The information processing apparatus according to claim 1, wherein the first module comprises a display that displays the usage charge calculated by the calculating unit.

5. The information processing apparatus according to claim 1, wherein the first module comprises a billing unit that bills the usage charge calculated by the calculating unit.

6. The information processing apparatus according to claim 1,
wherein the second information output by the output unit comprises an amount of service that is an amount of media processed in the service, and
wherein the calculating unit calculates the usage charge based on the amount of service.

7. The information processing apparatus according to claim 2, wherein the first module includes a displaying unit that displays information indicating that the usage charge is not calculated if the second module does not include the calculating unit identified by the first information.

8. The information processing apparatus according to claim 1, wherein the second module comprises a memory that stores rates that are used to calculate the usage charges in monetary units of a plurality of countries, and
wherein the calculating unit calculates the usage charge in accordance with a predetermined monetary unit based on a rate.

9. An information processing method comprising:
outputting first information responsive to information identifying a user, and second information related to a service used by the user; and
calculating a usage charge of the service corresponding to the first information and the second information.

10. A non-transitory computer readable medium storing a program causing a computer to execute a process for processing information, the process comprising:
outputting first information responsive to information identifying a user, and second information related to a service used by the user; and
calculating a usage charge of the service corresponding to the first information and the second information.
